(19) United States
(12) Patent Application Publication
(10) Pub. No.: US 2025/0214187 A1
(43) Pub. Date: Jul. 3, 2025

(54) TABLE DETACHABLE ASSEMBLY FOR FIVE-AXIS MACHINING FOR THREE-AXIS MACHINE TOOL

(71) Applicant: CHANGWON NATIONAL UNIVERSITY INDUSTRY ACADEMY COOPERATION CORPS, Changwon-si, Gyeongsangnam-do (KR)

(72) Inventors: Jae Sun LEE, Changwon-si (KR); Sun Do HWANG, Changwon-si (KR); Yeong ll CHOI, Changwon-si (KR)

(73) Assignee: CHANGWON NATIONAL UNIVERSITY INDUSTRY ACADEMY COOPERATION CORPS, Changwon-si, Gyeongsangnam-do (KR)

(21) Appl. No.: 18/850,434

(22) PCT Filed: Mar. 24, 2023
(86) PCT No.: PCT/KR2023/003911

§ 371 Date: Sep. 24, 2024

(30) Foreign Application Priority Data
Mar. 25, 2022 (KR) 10-2022-0037500

(51) Int. Cl. B23Q 1/25

(52) U.S. Cl. CPC B23Q 1/25

(57) ABSTRACT

A table-detachable assembly for five-axis machining of a three-axis machine tool according to an embodiment of the present invention may be detachably installed on a table of a three-axis machine tool to perform five-axis machining by operating an object to be processed of the three-axis machine tool in two-axis machining directions that are different from three-axis machining directions of the three-axis machine tool.

### TECHNICAL FIELD

The present invention relates to a table-detachable assembly for five-axis machining of a three-axis machine tool, and more particularly to a table-detachable assembly for five-axis machining of a three-axis machine tool, the table-detachable assembly being detachably mounted on a table of a three-axis machine tool that performs 3-axis machining, and thus, being capable of performing five-axis machining using the three-axis machine tool.

### BACKGROUND ART

In general, machine tools are a general term for machines for manufacturing machines, and usually refer mainly to metalworking machines. That is, a machine tool is a machine that cuts a metal, digs a hole, performs drilling, cuts screws, performs grinding, etc. using a cutting tool to process a metal material into a required shape. As representative examples of machine tools, there are lathes and machining centers (MCT).

The machine tools can be classified according to the number of machining axes. Currently, a three-axis machine tool and a five-axis machine tool are the most widely used. A three-axis machine tool can perform 3-axis machining based on three processing axes, and a five-axis machine tool can perform five-axis machining based on five processing axes.

In general, a five-axis machine tool has the advantage of being able to process various surfaces, but it requires a separate controller, so its unit price is very high, making it difficult to use in small and medium-sized enterprises or small workshops. In particular, a three-axis machine tool is more cost-effective than a five-axis machine tool for three-axis machining work, but, if it is required to perform five-axis machining work even once, there is no choice but to purchase a five-axis machine tool, which deteriorates cost-effectiveness and work efficiency of the machine tool overall.

Therefore, there is an urgent need to develop technology to perform five-axis machining using an existing three-axis machine tool without a five-axis machine tool. As a related art document, there is Korean Patent Publication Application No. 10-2019-0001140 (Invention Title: Rotary table assembly for machine tool, published on Jan. 4, 2019).

### DISCLOSURE

### Technical Problem

Therefore, the present invention has been made in view of the above problems, and it is one object of the present invention to provide a table-detachable assembly for five-axis machining of a three-axis machine tool, the table-detachable assembly being capable of being detachably mounted on a table of a three-axis machine tool, and thus, capable of providing five-axis machining even using the three-axis machine tool.

It is another object of the present invention to provide a table-detachable assembly for five-axis machining of a three-axis machine tool, wherein the table-detachable assembly can be further provided with two-axis machining directions different from three-axis machining directions of a three-axis machine tool by being simply mounted on a table of the three-axis machine tool, so that five-axis machining can be performed using an existing three-axis machine tool, and thus, the utilization of the existing three-axis machine tool can be increased.

### Technical Solution

In accordance with an aspect of the present invention, the above and other objects can be accomplished by the provision of a table-detachable assembly for five-axis machining of a three-axis machine tool, the table-detachable assembly being detachably installed at a table of a three-axis machine tool to perform five-axis machining by operating a to-be-processed object of the three-axis machine tool in two-axis machining directions different from three-axis machining directions of the three-axis machine tool.

Preferably, the table-detachable assembly according to an embodiment of the present invention may include a table member fixed to the to-be-processed object; a first table rotator connected to the table member to rotate the table member in a first axis machining direction different from the three-axis machining directions of the three-axis machine tool; a first power provider for providing power to the first table rotator; a second table rotator connected to the first table rotator to rotate the first table rotator and the table member in a second axis machining direction different from the three-axis machining directions of the three-axis machine tool and the first axis machining direction; a second power provider for providing power to the second table rotator to rotate the second table rotator in a preset angle range; and an assembly-detachable part provided at the second table rotator to install the second table rotator at the table of the three-axis machine tool.

Preferably, the first table rotator may include: an output spindle rotatably disposed in an axial direction identical to a virtual normal direction perpendicular to an upper surface of the table member, one end of the output spindle being connected to the table member; an input spindle rotatably disposed in an axial direction orthogonal to the output spindle, a power of the first power provider being input to one end of the input spindle; a bevel gear set provided at a location, where another end of the output spindle and another end of the input spindle intersect, to transmit a rotational power of the input spindle to the output spindle; and a first rotator casing for accommodating the output spindle and the input spindle and the bevel gear set.

Here, the first power provider may be provided as a motor control system for providing a rotational power of a motor to the input spindle. Here, the output spindle may control a rotation angle, rotation speed, and rotation direction of the table member depending upon a rotational power of the motor control system transmitted through the input spindle and the bevel gear set.

Preferably, the second table rotator may include: a second rotator casing for rotatably supporting a cylindrical part of the first rotator casing which surrounds the input spindle in a cylindrical shape; a rack gear member provided to be movable in a direction orthogonal to the cylindrical part at a position that corresponds to the cylindrical part in the second rotator casing, and moved by power of the second power provider; and a pinion gear member installed on an outer surface of the cylindrical part along a circumferential direction of the cylindrical part to be coupled with the rack gear member, and configured to rotate together with the cylindrical part when the rack gear member moves.

Here, the second table rotator may further include: a hydraulic piston provided at opposite ends of the rack gear member; and a hydraulic cylinder formed inside the second rotator casing in a cylinder shape to movably accommodate the hydraulic piston and the rack gear member, and configured to move the hydraulic pressure piston together with the rack gear member by a power of the second power provider.

In addition, the second power provider may be provided as a hydraulic pressure control system for supplying a hydraulic pressure to the hydraulic cylinder. The first rotator casing may rotate together with the output spindle and the table member around a central axis of the cylindrical part according to a hydraulic pressure of the hydraulic pressure control system transmitted through the rack gear member and the pinion gear member.

Preferably, the input spindle may include: a first input spindle disposed inside the first rotator casing and the second rotator casing in a direction orthogonal to an axial direction of the output spindle, one end of the first input spindle being rotatably supported inside the second rotator casing, and another end of the first input spindle being rotatably disposed inside the cylindrical part and being connected to the bevel gear set; a second input spindle rotatably disposed inside the second rotator casing to be parallel to the first input spindle, one end of the second input spindle being connected to the first power provider; and a power transmission member provided at another end of the second input spindle and one end of the first input spindle to transmit a power of the first power provider from the second input spindle to the first input spindle.

Preferably, the first axis machining direction and the second axis machining direction may be set in a direction intersecting with the three-axis machining directions of the three-axis machine tool, or are set in a rotation direction around the three-axis machining directions of the three-axis machine tool.

The three-axis machine tool may include a three-axis machining center (MCT). Here, three-axis machining directions of the three-axis MCT may be set to a Z-axis machining direction corresponding to a height direction of a machining spindle of the three-axis MCT, an X-axis machining direction corresponding to a horizontal direction of a table of the three-axis MCT, and a Y-axis machining direction corresponding to a vertical direction of the table of the three-axis MCT.

The first axis machining direction may be set to a C-axis machining direction where the table member is rotated around the Z-axis, and the second axis machining direction may be set to an A-axis machining direction where the table member is rotated around the X-axis.

Preferably, the assembly-detachable part may be provided as an integral structure with the second rotator casing, and may be detachably mounted on the table of the three-axis machine tool by at least one of a clamp and a fastening member.

### Advantageous Effects

A table-detachable assembly for five-axis machining of a three-axis machine tool according to the present invention can be detachably mounted on a table of a three-axis machine tool, so that five-axis machining can be performed even using a three-axis machine tool, and both 3-axis machining and 5-axis machining can be smoothly performed using a 3-axis machine tool without purchasing an expensive 5-axis machine tool.

In addition, the table-detachable assembly for five-axis machining of a three-axis machine tool according to an embodiment of the present invention can add two-axis machining directions, different from three-axis machining directions of a three-axis machine tool, through a simple structural change of mounting on a table of the three-axis machine tool, so that five-axis machining can be smoothly performed even using an existing three-axis machine tool, and, compared to purchasing and using a five-axis machine tool, the cost burden can be greatly reduced while increasing the usability of a three-axis machine tool.

In addition, since the table-detachable assembly for five-axis machining of a three-axis machine tool according to an embodiment of the present invention has a structure wherein the power of a first power provider which is input to an input spindle of a first table rotator is transmitted to an output spindle, orthogonal to the input spindle, through a bevel gear set, and then a table member rotates together with the output spindle in a first axis machining direction, the table-detachable assembly can be connected to a power transmit structure orthogonal to the input spindle and the output spindle using the bevel gear set and can stably transmit the rotational power of a motor of the first power provider to the table member.

Further, since the table-detachable assembly for five-axis machining of a three-axis machine tool according to an embodiment of the present invention has a structure wherein the hydraulic pressure of a second power provider which is input to a rack gear member of the second table rotator is transmitted to a cylindrical part of a first rotator casing through a pinion gear member, and then an output spindle and a table member rotate together with the first rotator casing in a second axis machining direction, the first rotator casing, an output casing and the table member can be rotated together by the second table rotator without being affected by the operations of the first power provider and the first table rotator. Accordingly, in the present embodiment, the second table rotator can rotate the table member in the second axis machining direction by rotating the first rotator casing, and, at the same time, the first table rotator can stably transmit a power from the input spindle to the output spindle through the bevel gear without being affected by the operation of the second table rotator set so that the table member can be smoothly rotated in the first axis machining direction.

### DESCRIPTION OF DRAWINGS

FIG. 1 illustrates a perspective view of a table-detachable assembly for five-axis machining of a three-axis machine tool according to an embodiment of the present invention.

FIG. 2 illustrates a side view of the table-detachable assembly illustrated in FIG. 1.

FIG. 3 illustrates a perspective view of the table-detachable assembly, from which a table member and a second rotator casing have been removed, illustrated in FIG. 1.

FIG. 4 illustrates a cross-sectional view of the internal structure of the table-detachable assembly illustrated in FIG. 2.

FIG. 5 illustrates a cross-sectional view of the internal structure of the table-detachable assembly illustrated in FIG. 1.

FIG. 6 illustrates a process where the power of a first power provider is transmitted to a table member in a first axis machining direction by a first table rotator in the table-detachable assembly illustrated in FIG. 4.

FIG. 7 illustrates a process where the power of second power providers is transmitted to a table member in a second axis machining direction by a second table rotator in the table-detachable assembly illustrated in FIG. 4.

### BEST MODE

The present invention will now be described more fully with reference to the accompanying drawings, in which exemplary embodiments of the invention are shown. This invention may, however, be embodied in many different forms and should not be construed as limited to the exemplary embodiments set forth herein. Like reference numerals in the drawings denote like elements.

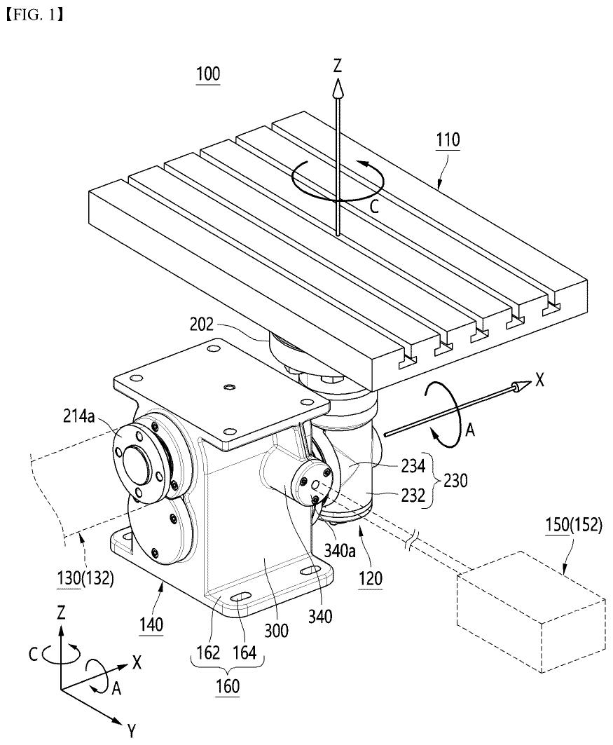

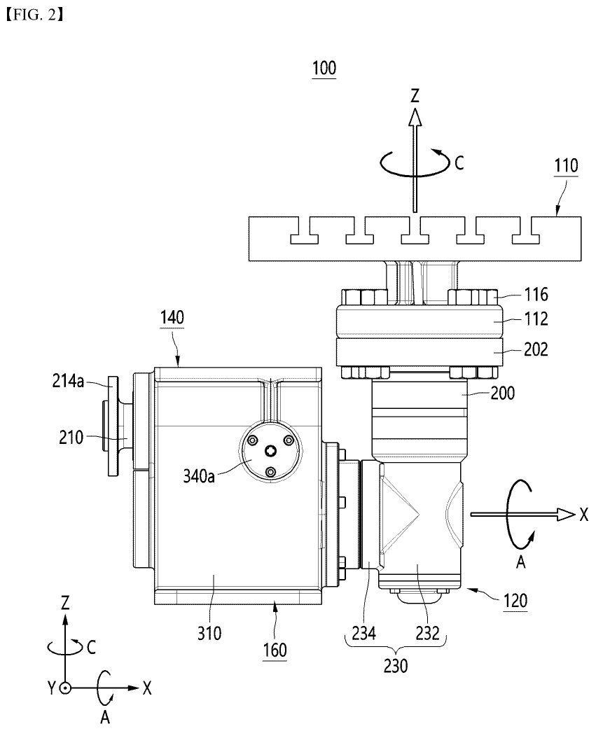

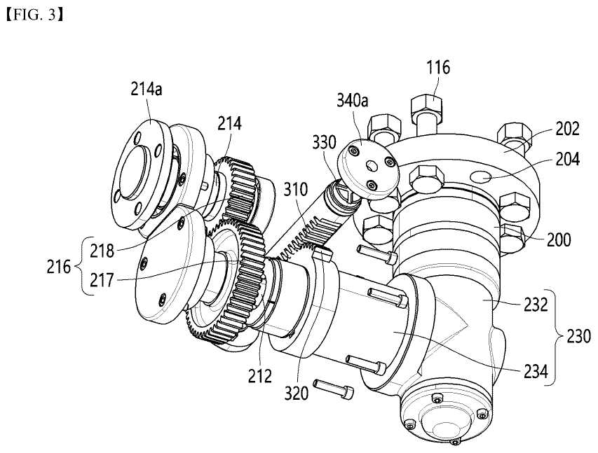

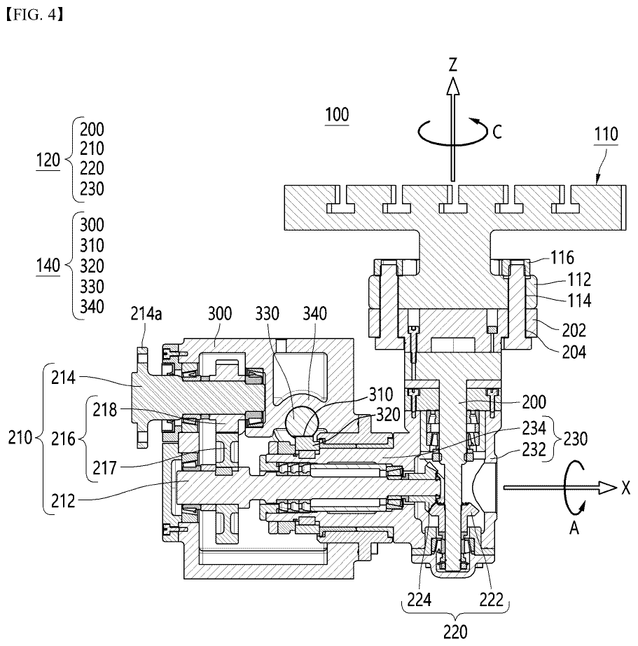

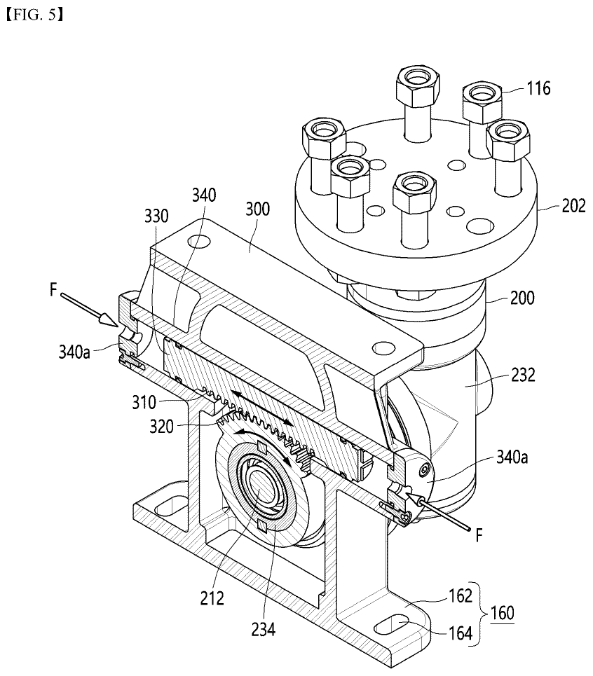

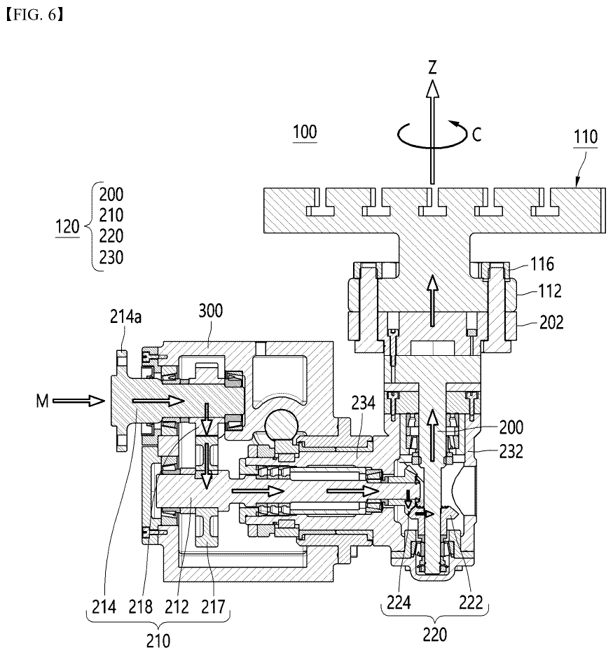

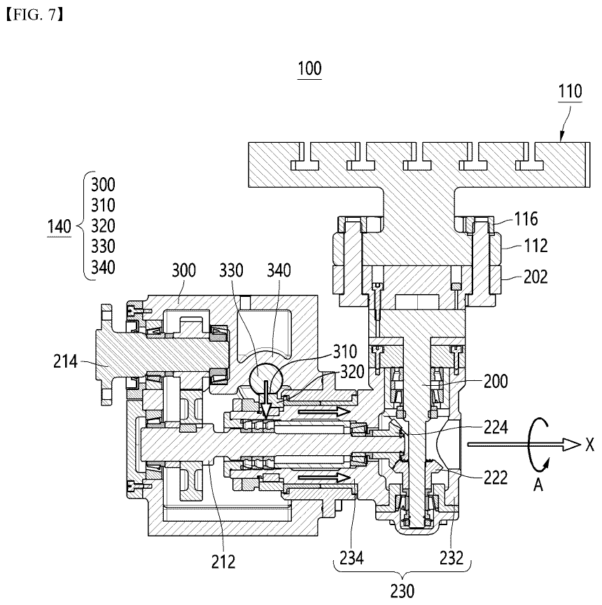

FIG. 1 illustrates a perspective view of a table-detachable assembly 100 for five-axis machining of a three-axis machine tool according to an embodiment of the present invention, FIG. 2 illustrates a side view of the table-detachable assembly 100 illustrated in FIG. 1, and FIG. 3 illustrates a perspective view of the table-detachable assembly 100, from which a table member 110 and a second rotator casing 300 have been removed, illustrated in FIG. 1. FIG. 4 illustrates a cross-sectional view of the internal structure of the table-detachable assembly 100 illustrated in FIG. 2, and FIG. 5 illustrates a cross-sectional view of the internal structure of the table-detachable assembly 100 illustrated in FIG. 1. FIG. 6 illustrates a process where the power of a first power provider 130 is transmitted to a table member 110 in a first axis machining direction C by a first table rotator 120 in the table-detachable assembly 100 illustrated in FIG. 4, and FIG. 7 illustrates a process where the power of second power providers 150 is transmitted to a table member 110 in a second axis machining direction A by a second table rotator 140 in the table-detachable assembly 100 illustrated in FIG. 4.

Referring to FIGS. 1 and 2, the table-detachable assembly 100 for five-axis machining of a three-axis machine tool according to an embodiment of the present invention may be detachably mounted on a table of a three-axis machine tool such that five-axis machining can be performed using an existing three-axis machine tool.

Here, the three-axis machine tool may include various metalworking machines with three-axis machining directions, such as a lathe or a machining center. However, in this embodiment, the three-axis machine tool is limited to a three-axis machining center (MCT) for the convenience of explanation.

The three-axis machining directions X, Y and Z of the three-axis machining center may be set to a Z-axis machining direction Z corresponding to the height direction of a machining spindle equipped with a bit for metalworking, an X-axis machining direction X corresponding to the horizontal direction of a table, and a Y-axis machining direction Y corresponding to the vertical direction of the table. Accordingly, a machining spindle of the three-axis machining center may be moved in at least one direction of the X-axis machining direction X, the Y-axis machining direction Y and the Z-axis machining direction Z in a process of performing 3-axis machining.

In addition, when five-axis machining using the three-axis machine tool is necessary, the table-detachable assembly 100 may be detachably mounted on a table of a three-axis machine tool, and may perform five-axis machining with the three-axis machine tool by operating a to-be-processed object in two-axis machining directions A and C different from the three-axis machining directions X, Y and Z of the three-axis machine tool.

The first axis machining direction C and the second axis machining direction A may be set to a direction for moving a to-be-processed object linearly in a direction intersecting the three-axis machining directions X, Y and Z of the three-axis machine tool or may be set to a direction for rotating the to-be-processed object around the three-axis machining directions X, Y and Z of the three-axis machine tool. For example, the first axis machining direction C may be set to a C-axis machining direction C that rotates the to-be-processed object around the Z-axis, and the second axis machining direction A may be set to an A-axis machining direction A that rotates the to-be-processed object around the X-axis.

Meanwhile, an installation structure for detachably mounting the table-detachable assembly 100 on the table of the three-axis machine tool may be provided. For example, the installation structure of the table may be provided as a structure of mounting the table-detachable assembly 100 on the table using a fastening member or a clamp. Accordingly, it is preferred that the table-detachable assembly 100 is formed as compactly as possible.

Hereinafter, the detailed configuration of the table-detachable assembly 100 of the present embodiment is described in more detail.

Referring to FIGS. 1 to 4, the table-detachable assembly 100 according to an embodiment of the present invention may include the table member 110, the first table rotator 120, the first power provider 130, the second table rotator 140, the second power provider 150, and an assembly-detachable part 160.

The table-detachable assembly 100 of the present embodiment may be detachably installed on the table of the three-axis machine tool in a state of being seated on the table. Here, a to-be-processed object requiring five-axis machining may be disposed on the table member 110 of the table-detachable assembly 100. The table-detachable assembly 100 may provide machining of the to-be-processed object in the first axis machining direction C and the second axis machining direction A using powers M and F of the first power provider 130 and the second power provider 150.

Specifically, the three-axis machine tool equipped with the table-detachable assembly 100 may perform 3-axis machining for a to-be-processed object in the X-axis machining direction X, the Y-axis machining direction Y and the Z-axis machining direction Z of an existing three-axis machine tool, and may additionally perform two-axis machining for the to-be-processed object in the A-axis machining direction A and the C-axis machining direction C. Accordingly, the three-axis machine tool equipped with the table-detachable assembly 100 may perform five-axis machining for the to-be-processed object, so that the curved surface of the to-be-processed object may also be smoothly processed.

Referring to FIGS. 1 to 4, the table member 110 of the present embodiment may be provided to fix the to-be-processed object. That is, the table member 110 may perform a function of fixing and supporting the to-be-processed object instead of the table of the three-axis machine tool. For this, the table member 110 is preferably formed in a structure identical or similar to the table of the three-axis machine tool

As a lower part of the table member 110, a structure for connection to an output spindle 200 of the first table rotator 120 may be formed. For example, a table flange 112 may be formed at the lower part of the table member 110, and a plurality of table-fastening holes 114 may be formed in the table flange 112. The table flange 112 may be fastened and fixed to the output spindle 200 of the first table rotator 120 using table-fastening members 116.

Referring to FIGS. 1 to 4, the first table rotator 120 of the present embodiment may rotate the table member 110 in the first axis machining direction C different from the three-axis machining directions X, Y and Z of the three-axis machine tool. The first table rotator 120 may be connected to the lower part of the table member 110. For reference, the first axis machining direction C may be set to the C-axis machining direction C that rotates around the Z-axis machining direction Z of the three-axis machine tool.

For example, the first table rotator 120 may include the output spindle 200, an input spindle 210, a bevel gear set 220, and a first rotator casing 230.

The output spindle 200 may be disposed inside the first rotator casing 230 so as to be rotatable in the same axial direction as a virtual normal direction perpendicular to an upper surface of the table member 110. An upper part of the output spindle 200 may be connected to the lower part of the table member 110 so that the output spindle 200 may rotate integrally with the table member 110.

For this, a spindle flange 202 may be formed on the upper part of the output spindle 200 to be disposed in close contact with the table flange 112 of the table member 110, and a plurality of spindle-fastening holes 204 for fastening the table-fastening members 116 may be formed in the spindle flange 202. Here, as the table-fastening members 116 are fastened to the spindle-fastening holes 204 and the table-fastening holes 114, the table flange 112 and the spindle flange 202 may be firmly connected to each other.

The input spindle 210 may be disposed to be rotatable in an axial direction orthogonal to the output spindle 200. One end of the input spindle 210 may receive the power M of the first power provider 130, and the other end of the input spindle 210 may be disposed at a position close to a lower end of the output spindle 200 along an axial direction orthogonal to the output spindle 200. The other end of the input spindle 210 and the lower end of the output spindle 200 may be connected to each other to transmit power via the bevel gear set 220.

For example, the input spindle 210 may include a first input spindle 212, a second input spindle 214, and a power transmission member 216.

Here, the first input spindle 212 may be disposed inside the first rotator casing 230, and the second rotator casing 300, described below, in a direction orthogonal to the axial direction of the output spindle 200. One end of the first input spindle 212 may be rotatably supported inside the second rotator casing 300, and the other end of the first input spindle 212 may be rotatably disposed inside a cylindrical part 234 included in the first rotator casing 230. The other end of the first input spindle 212 may be connected to the lower end of the output spindle 200 via the bevel gear set 220 to transmit power.

In addition, the second input spindle 214 may be rotatably disposed inside the second rotator casing 300. The second input spindle 214 may be disposed parallel to the first input spindle 212. A motor connector 214a may be provided to one end of the second input spindle 214 to be connected to the first power provider 130 in a power transmission manner. The other end of the second input spindle 214 may be connected to one end of the first input spindle 212 in a power transmission manner via the power transmission member 216.

In addition, the power transmission member 216 may be provided to transmit the power M of the first power provider 130 from the second input spindle 214 to the first input spindle 212. The power transmission member 216 may be provided at the other end of the second input spindle 214 and one end of the first input spindle 212. For example, the power transmission member 216 may include a first spur gear 217 connected to the end of the first input spindle 212, and a second spur gear 218 connected to the other end of the second input spindle 214 to be coupled to the first spur gear 217.

The bevel gear set 220 may be provided to transmit a rotational power of the input spindle 210 to the output spindle 200. That is, the bevel gear set 220 may be provided at a position where the lower end of the output spindle 200 and the other end of the first input spindle 212 intersect each other. Accordingly, the bevel gear set 220 may convert the power M transmission direction of the first power provider 130 into a direction orthogonal to the first input spindle 212 and transmit it to the output spindle 200, and may rotate the output spindle 200 around the other end of the first input spindle 212 while maintaining the other end of the first input spindle 212 and the lower end of the output spindle 200 in a state where power transmission is possible.

For example, the bevel gear set 220 may include a first bevel gear 222 disposed at the lower end of the output spindle 200, and a second bevel gear 224 disposed at the other end of the first input spindle 212.

The first rotator casing 230 may be formed to accommodate the output spindle 200, the first input spindle 212 and the bevel gear set 220. The first rotator casing 230 may rotatably support the output spindle 200 and the other end of the first input spindle 212. Meanwhile, the first rotator casing 230 may rotate together with the output spindle 200 and the table member 110 around the first input spindle 212 when rotating by the second table rotator 140.

For example, the first rotator casing 230 may include a spindle casing 232 and the cylindrical part 234.

The spindle casing 232 may be formed in a cylindrical structure of surrounding the outside of the output spindle 200 to accommodate the output spindle 200 and the bevel gear set 220 thereinside. Here, the upper part of the spindle casing 232 may have an open structure, and the upper part of the output spindle 200 may be exposed to the outside through the upper part of the spindle casing 232 to be connected to the lower part of the table member 110. At the upper part of the output spindle 200, the spindle flange 202 may be formed.

The cylindrical part 234 may be lengthily extended in a cylindrical structure to be connected to the side surface of the spindle casing 232. The other end of the first input spindle 212 may be rotatably disposed inside the cylindrical part 234. That is, since a bearing is disposed between the cylindrical part 234 and the other end of the first input spindle 212, the other end of the first input spindle 212 may be rotatably supported by the cylindrical part 234. The cylindrical part 234 is preferably disposed at a position facing the bevel gear set 220.

Referring to FIGS. 1 to 4, the first power provider 130 of the present embodiment may provide power to the first table rotator 120 to rotate the table member 110 in the C-axis machining direction C. For example, the first power provider 130 may be provided as a motor control system 132 connected to the motor connector 214a of the second input spindle 214. The motor control system 132 may provide the rotational power M of the motor through the motor connector 214a of the second input spindle 214.

Accordingly, the output spindle 200 may variously adjust the rotation angle, rotation speed, and rotation direction of the table member 110 depending upon the rotational motor power M of the motor control system 132 transmitted through the input spindle 210 and the bevel gear set 220.

Referring to FIGS. 1 to 5, the second table rotator 140 of the present embodiment may rotate the first table rotator 120 and the table member 110 in the three-axis machining directions X, Y and Z of the three-axis machine tool and in the second axis machining direction A different from the first axis machining direction C. The second table rotator 140 may be connected to the cylindrical part 234 of the first table rotator 120 to rotatably support the cylindrical part 234 of the first table rotator 120.

For example, the second table rotator 140 may include the second rotator casing 300, a rack gear member 310, a pinion gear member 320, a hydraulic piston 330, and a hydraulic cylinder 340.

Here, the second rotator casing 300 may be provided to rotatably support the cylindrical part 234 of the first rotator casing 230. The second rotator casing 300 may be formed in a box shape to rotatably accommodate the end of the first input spindle 212 and the second input spindle 214.

In addition, the rack gear member 310 may be disposed inside the second rotator casing 300, and may be provided at a location corresponding to the cylindrical part 234 to be moveable in a direction orthogonal to the axial direction of the cylindrical part 234. That is, the rack gear member 310 may be accommodated in the hydraulic cylinder 340 formed inside the second rotator casing 300, and may be reciprocally moved along the hydraulic cylinder 340 by the power F of the second power provider 150.

In addition, the pinion gear member 320 may be installed on the outer surface of the cylindrical part 234 along the circumferential direction of the cylindrical part 234 to be coupled with the rack gear member 310. The pinion gear member 320 may be rotated together with the cylindrical part 234 when the rack gear member 310 moves. That is, the cylindrical part 234 of the first rotator casing 230 may be rotated by the rack gear member 310 and pinion gear member 320 that are operated by the power F of the second power provider 150.

Gear teeth of the pinion gear member 320 may be provided only in a preset angle range, and gear teeth of the rack gear member 310 may also be provided only in a preset length range. Accordingly, the pinion gear member 320 and the rack gear member 310 operate in the preset ranges, so that the cylindrical part 234 may also be rotated in a preset rotation range. Accordingly, the table member 110 may be rotated in a preset rotation range in the second axis machining direction A.

In addition, the hydraulic piston 330 may be provided at each of opposite ends of the rack gear member 310. The hydraulic piston 330 is a member for performing the role of a piston, and may be slidably moved in close contact with the inner wall of the hydraulic cylinder 340.

In addition, the hydraulic cylinder 340 may be provided in a cylinder shape surrounding the rack gear member 310 and the hydraulic piston 330. That is, the hydraulic cylinder 340 may be formed in a cylinder shape inside the second rotator casing 300 so as to movably accommodate the hydraulic piston 330 and the rack gear member 310. When the power F of the second power provider 150 is provided to the hydraulic cylinder 340, the hydraulic piston 330 may be moved together with the rack gear member 310 along the inside of the hydraulic cylinder 340.

Here, an opening of the hydraulic cylinder 340 may be formed at a part facing the pinion gear member 320, and the rack gear member 310 may be disposed to be exposed through the opening of the hydraulic cylinder 340, thereby being coupled with the pinion gear member 320. However, opposite ends of the hydraulic cylinder 340 in which the hydraulic piston 330 is positioned are formed in a sealed structure, and a hydraulic pressure connector 340a may be provided at opposite side surfaces of the hydraulic piston 330 to receive a hydraulic pressure F of the second power provider 150.

Referring to FIGS. 1 to 5, the second power provider 150 of the present embodiment may provide a power F for the operation of the second table rotator 140. Second power providers 150 may be provided in different directions at the opposite side surfaces of the hydraulic piston 330 to rotate the second table rotator 140 in a preset angle range.

For example, the second power provider 150 may be provided as a hydraulic pressure control system 152 to provide the hydraulic pressure F through the hydraulic pressure connector 340a provided at opposite side surfaces of the hydraulic cylinder 340. Accordingly, the first rotator casing 230 may rotate around the central axis of the cylindrical part 234 together with the output spindle 200 and the table member 110 along the hydraulic pressure F of the hydraulic pressure control system 152 transmitted through the rack gear member 310 and the pinion gear member 320.

Referring to FIGS. 1 to 2, the second rotator casing 300 of the second table rotator 140 may be detachably installed at the table of the three-axis machine tool by the assembly-detachable part 160 of the present embodiment. The assembly-detachable part 160 may be provided in a structure integrated with the second rotator casing 300 of the second table rotator 140.

For example, the assembly-detachable part 160 may include a detachable flange 162 formed as an integral structure with the second rotator casing 300, a plurality of detachable fastening holes 164 formed in the detachable flange 162, and detachable fastening members (not shown) fastened to the detachable fastening holes 164 to detachably fix the detachable flange 162 to the table of the three-axis machine tool. Differently from this, the assembly-detachable part 160 may use clamp members to detachably mount the second rotator casing 300 on the table of the three-axis machine tool.

Meanwhile, in the table-detachable assembly 100 of the present embodiment, the first spur gear 217 and second spur gear 218 of the power transmission member 216 and a first bevel gear 222 and second bevel gear 224 of the bevel gear set 220 may be connected to the output spindle 200, the first input spindle 212 or the second input spindle 214 using a round key.

In addition, in the table-detachable assembly 100 of the present embodiment, since thrust in an axial direction is generated in the gear parts such as the first spur gear 217 and second spur gear 218 of the power transmission member 216, the first bevel gear 222 and second bevel gear 224 of the bevel gear set 220, and the pinion gear member 320, all bearings may be tapered bearings. In particular, a tapered roller bearing may be used at a part in contact with the first bevel gear 222 and second bevel gear 224 of the bevel gear set 220.

As shown in FIG. 6, FIG. 6 illustrates a state in which the table member 110 is rotated in the first axis machining direction C by the first table rotator 120 using the power M of the first power provider 130. An arrow illustrated in FIG. 6 indicates a direction in which the rotational motor power M of the motor control system 132 of the first power provider 130 is transmitted, and the rotational motor power M may be transmitted to the table member 110 in the arrow direction.

Specifically, when the rotational motor power M of the motor control system 132 is provided to the motor connector 214a of the second input spindle 214, the rotational motor power M may be transmitted to the second input spindle 214, the second spur gear 218, the first spur gear 217, the second input spindle 214, the second bevel gear 224, the first bevel gear 222, the output spindle 200, and the table member 110. The table member 110 may be rotated along the C-axis machining direction C according to the rotational motor power M.

As shown in FIG. 7, FIG. 7 illustrates a state in which the table member 110 is rotated in the second axis machining direction A by the second table rotator 140 using the power F of the second power provider 150. An arrow illustrated in FIG. 7 indicates a direction in which the rotational power according to the hydraulic pressure F of the hydraulic pressure control system 152 of the second power provider 150 is transmitted, and the rotational power of the hydraulic pressure may be transmitted to the first rotator casing 230 connected to the table member 110 in the arrow direction.

Specifically, when the hydraulic pressure F of the hydraulic pressure control system 152 is provided to the hydraulic pressure connector 340a of the hydraulic cylinder 340, the rack gear member 310 may transmit the rotational power to the pinion gear member 320 while linearly reciprocating along the hydraulic cylinder 340 by the hydraulic pressure F, the rotational power of the pinion gear member 320 may be transmitted to the cylindrical part 234 of the first rotator casing 230 so that the first rotator casing 230 may rotate, and the output spindle 200 and the table member 110 may rotate together with the first rotator casing 230. The table member 110 may be spun in the A-axis machining direction A by the hydraulic pressure F of the hydraulic pressure control system 152 regardless of whether it is rotated along the C-axis machining direction C according to the rotational motor power M.

As described above, the embodiments of the present invention have been explained with reference to specific details, such as specific components, and limited embodiments and drawings, but these are only provided to help a more general understanding of the present invention, and the present invention is not limited to the embodiments. Various modifications and variations can be made from these descriptions by those with ordinary knowledge in the field to which the present invention belongs. Therefore, it should be understood that the idea of the present invention is not limited to the described embodiments, and not only the accompanying claims, but also all particulars that are equivalent or alternative to the scope of the claims fall into the category of the idea of the present invention.

### INDUSTRIAL APPLICABILITY

Included in the text.

1. A table-detachable assembly for five-axis machining of a three-axis machine tool, the table-detachable assembly being detachably installed at a table of a three-axis machine tool to perform five-axis machining by operating a to-be-processed object of the three-axis machine tool in two-axis machining directions different from three-axis machining directions of the three-axis machine tool.

2. The table-detachable assembly according to claim 1, comprising:
a table member fixed to the to-be-processed object;
a first table rotator connected to the table member to rotate the table member in a first axis machining direction different from the three-axis machining directions of the three-axis machine tool;
a first power provider for providing power to the first table rotator;
a second table rotator connected to the first table rotator to rotate the first table rotator and the table member in a second axis machining direction different from the three-axis machining directions of the three-axis machine tool and the first axis machining direction;
a second power provider for providing power to the second table rotator to rotate the second table rotator in a preset angle range; and
an assembly-detachable part provided at the second table rotator to install the second table rotator at the table of the three-axis machine tool.

3. The table-detachable assembly according to claim 2, wherein the first table rotator comprises:
an output spindle rotatably disposed in an axial direction identical to a virtual normal direction perpendicular to an upper surface of the table member, one end of the output spindle being connected to the table member;
an input spindle rotatably disposed in an axial direction orthogonal to the output spindle, a power of the first power provider being input to one end of the input spindle;
a bevel gear set provided at a location, where another end of the output spindle and another end of the input spindle intersect, to transmit a rotational power of the input spindle to the output spindle; and
a first rotator casing for accommodating the output spindle and the input spindle and the bevel gear set.

4. The table-detachable assembly according to claim 3, wherein the first power provider is provided as a motor control system for providing a rotational power of a motor to the input spindle, and
the output spindle controls a rotation angle, rotation speed, and rotation direction of the table member depending upon a rotational power of the motor control system transmitted through the input spindle and the bevel gear set.

5. The table-detachable assembly according to claim 3, wherein the second table rotator comprises:
a second rotator casing for rotatably supporting a cylindrical part of the first rotator casing which surrounds the input spindle in a cylindrical shape;
a rack gear member provided to be movable in a direction orthogonal to the cylindrical part at a position that corresponds to the cylindrical part in the second rotator casing, and moved by power of the second power provider; and
a pinion gear member installed on an outer surface of the cylindrical part along a circumferential direction of the cylindrical part to be coupled with the rack gear member, and configured to rotate together with the cylindrical part when the rack gear member moves.

6. The table-detachable assembly according to claim 5, wherein the second table rotator further comprises:
a hydraulic piston provided at opposite ends of the rack gear member; and
a hydraulic cylinder formed inside the second rotator casing in a cylinder shape to movably accommodate the hydraulic piston and the rack gear member, and configured to move the hydraulic pressure piston together with the rack gear member by a power of the second power provider.

7. The table-detachable assembly according to claim 6, wherein the second power provider is provided as a hydraulic pressure control system for supplying a hydraulic pressure to the hydraulic cylinder, and
the first rotator casing rotates together with the output spindle and the table member around a central axis of the cylindrical part according to a hydraulic pressure of the hydraulic pressure control system transmitted through the rack gear member and the pinion gear member.

8. The table-detachable assembly according to claim 5, wherein the input spindle comprises:
a first input spindle disposed inside the first rotator casing and the second rotator casing in a direction orthogonal to an axial direction of the output spindle, one end of the first input spindle being rotatably supported inside the second rotator casing, and another end of the first input spindle being rotatably disposed inside the cylindrical part and being connected to the bevel gear set;
a second input spindle rotatably disposed inside the second rotator casing to be parallel to the first input spindle, one end of the second input spindle being connected to the first power provider; and
a power transmission member provided at another end of the second input spindle and one end of the first input spindle to transmit a power of the first power provider from the second input spindle to the first input spindle.

9. The table-detachable assembly according to claim 2, wherein the first axis machining direction and the second axis machining direction are set in a direction intersecting with the three-axis machining directions of the three-axis machine tool, or are set in a rotation direction around the three-axis machining directions of the three-axis machine tool.

10. The table-detachable assembly according to claim 9, wherein the three-axis machine tool comprises a three-axis machining center (MCT),
wherein three-axis machining directions of the three-axis MCT are set to a Z-axis machining direction corresponding to a height direction of a machining spindle of the three-axis MCT, an X-axis machining direction corresponding to a horizontal direction of a table of the three-axis MCT, and a Y-axis machining direction corresponding to a vertical direction of the table of the three-axis MCT, and
the first axis machining direction is set to a C-axis machining direction where the table member is rotated around the Z-axis, and the second axis machining direction is set to an A-axis machining direction where the table member is rotated around the X-axis.

11. The table-detachable assembly according to claim 5, wherein the assembly-detachable part is provided as an integral structure with the second rotator casing, and is detachably mounted on the table of the three-axis machine tool by at least one of a clamp and a fastening member.
